(19) United States
(12) Patent Application Publication
(10) Pub. No.: US 2026/0236210 A1
(43) Pub. Date: Aug. 13, 2026

(54) ELECTRONIC DEVICE, METHOD, AND NON-TRANSITORY COMPUTER READABLE STORAGE MEDIUM INCLUDING DISPLAYS ARRANGED AT ADJUSTABLE GAP

(71) Applicant: SAMSUNG ELECTRONICS CO., LTD., Suwon-si (KR)

(72) Inventor: Sunggyu LEE, Suwon-si (KR)

(73) Assignee: SAMSUNG ELECTRONICS CO., LTD., Suwon-si (KR)

(21) Appl. No.: 19/391,627

(22) Filed: Nov. 17, 2025

Related U.S. Application Data
(63) Continuation of application No. PCT/KR2025/017306, filed on Oct. 28, 2025.

(30) Foreign Application Priority Data
Feb. 12, 2025 (KR) 10-2025-0018331

(51) Int. Cl. G06F 3/14; G09F 9/302

(52) U.S. Cl. CPC G06F 3/1446; G09F 9/3026

(57) ABSTRACT

An electronic device including a first display configured to emit light toward a front surface of the first display, a second display, disposed in front of the front surface of the first display, configured to transmit light from a rear surface to a front surface, a distance adjusting unit configured to change a distance between the first display and the second display, at least one processor including processing circuitry, and memory including one or more storage mediums storing instructions. The instructions, when executed by the at least one processor individually or collectively, cause the electronic device to display a first screen through the first display, display a second screen through the second display, identify whether an event to change the distance, and adjust through the distance adjusting unit, based on the event, the distance between the first display and the second display.

### CROSS-REFERENCE TO RELATED APPLICATIONS

This application is a continuation application, under 35 U.S.C. § 111 (a), of International Patent Application No. PCT/KR2025/017306, filed on Oct. 28, 2025, which based on and claims benefit of priority under 35 U.S.C. § 119 to Korean Patent Applications No. 10-2025-0018331, filed on Feb. 12, 2025, in the Korean Intellectual Property Office, the disclosures of which are incorporated by reference herein in their entireties.

### TECHNICAL FIELD

The following descriptions relate to an electronic device, a method, and a non-transitory computer readable storage medium, which include displays arranged at an adjustable distance.

### BACKGROUND ART

A transparent display may display a screen while maintaining transparency that allows light from a front surface or a rear surface to transmit through the display. A display panel of the transparent display may include a liquid crystal display (LCD), an organic light-emitting diode (OLED), or a micro light-emitting diode (micro LED).

The transparent display is mainly utilized as a commercial display and is utilized as a show window and a showcase of a store, or a digital signboard.

An electronic device may include a multi-layer display in which two or more transparent display panels are arranged. The electronic device may display content through a plurality of displays of the multi-layer display.

### DISCLOSURE

### Technical Solution

An electronic device is disclosed. The electronic device may comprise a first display configured to emit light toward a front surface of the first display, a second display, to be disposed in front of the front surface of the first display, configured to transmit the light emitted toward the front surface of the first display from a rear surface of the second display to a front surface of the second display, a distance adjusting unit configured to change a distance between the first display and the second display, at least one processor comprising processing circuitry, and a memory comprising one or more storage mediums storing instructions. The instructions, when executed by the at least one processor individually or collectively, may cause the electronic device to display a first screen through the first display, display a second screen through the second display, identify whether an event to change the distance between the first display and the second display occurs, and adjust through the distance adjusting unit, based on the event being identified as having occurred, the distance between the first display and the second display.

A method is disclosed. The method may be performed by an electronic device. The method may comprise displaying a first screen through a first display, displaying a second screen through a second display disposed in front of a front surface of the first display, the second display being configured to transmit light emitted toward the front surface of the first display from a rear surface of the second display to a front surface of the second display, identifying whether an event to change a distance between the first display and the second display occurs, and adjusting, through a distance adjusting unit configured to change the distance between the first display and the second display based on the event being identified as having occurred.

A non-transitory computer readable storage medium is disclosed. The non-transitory computer readable storage medium may store a program comprising instructions. The instructions, when executed individually or collectively by at least one processor of an electronic device cause an operation to be performed by the electronic device. The electronic device comprising a first display configured to emit light toward a front surface, a second display disposed in front of the front surface of the first display, the second display being configured to transmit light emitted toward the front surface of the first display from a rear surface of the second display to a front surface of the second display, and a distance adjusting unit configured to change a distance between the first display and the second display, may cause the electronic device to display a first screen through the first display, display a second screen through the second display, identify whether an event to change the distance between the first display and the second display occurs, and according to identifying the event, adjust, through the distance adjusting unit, the distance between the first display and the second display based on the event being identified as having occurred.

### DESCRIPTION OF THE DRAWINGS

FIG. 1 is a block diagram of an electronic device according to an embodiment.

FIG. 2A is a perspective view of an electronic device in a state in which displays are spaced apart by a first distance, according to an embodiment.

FIG. 2B is a diagram exemplifying a screen displayed by an electronic device in a state in which displays are spaced apart by a first distance, according to an embodiment.

FIG. 3A is a perspective view of an electronic device in a state in which displays are spaced apart by a second distance, according to an embodiment.

FIG. 3B is a diagram exemplifying a screen displayed by an electronic device in a state in which displays are spaced apart by a second distance, according to an embodiment.

FIG. 4A is a diagram exemplifying a screen in which screens displayed by displays of an electronic device are overlapped, according to an embodiment.

FIG. 4B is a perspective view of an electronic device in a state in which displays are spaced apart by specific distances, according to an embodiment.

FIG. 4C is a perspective view of an electronic device in a state in which displays are spaced apart by other specific distances, according to an embodiment.

FIG. 4D is a diagram exemplifying another screen in which screens displayed by displays of an electronic device are overlapped, according to an embodiment.

FIG. 5A is a diagram exemplifying a screen in which screens displayed by displays of an electronic device are overlapped, according to an embodiment.

FIG. 5B is a perspective view of an electronic device in a state in which displays are spaced apart by a specific distance, according to an embodiment.

FIG. 5C is a perspective view of an electronic device in a state in which displays are spaced apart by another specific distance, according to an embodiment.

FIG. 6 is a flowchart indicating an operation of an electronic device according to an embodiment.

### MODE FOR INVENTION

The various embodiments of the present document and terms used herein are not intended to limit the technology described in the present document to specific embodiments, and should be understood to include various modifications, equivalents, or substitutes of the corresponding embodiment. In relation to the description of the drawings, a reference numeral may be used for a similar component. A singular expression may include a plural expression unless it is clearly meant differently in the context. In the present document, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, are only used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the present document may include a unit configured with hardware and may be used interchangeably with terms such as component and/or circuit. The module may be an integrally configured component or a minimum unit or part thereof that performs one or more functions. For example, a module may be configured with an application-specific integrated circuit (ASIC).

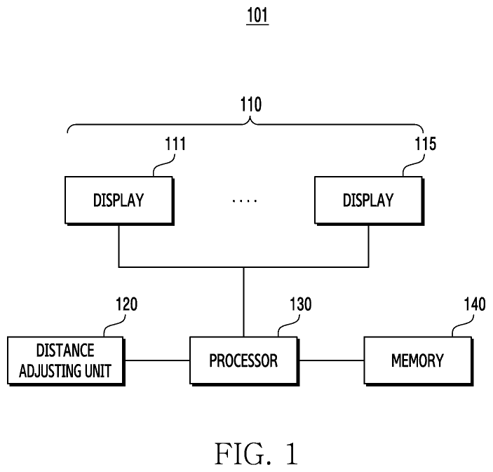

FIG. 1 is a block diagram of an electronic device according to an embodiment.

In FIG. 1, an electronic device 101 may be an electronic device capable of displaying a video. For example, the electronic device 101 may be a television (TV), a monitor, a computer, a smartphone, a tablet personal computer (PC), a portable media player, a wearable device, a video wall, or a digital photo frame. The electronic device 101 may be a display device. For example, the electronic device 101 may be a display device for a vehicle. For example, the electronic device 101 may be a display device mounted on a instrumental panel or a center fascia of the vehicle.

In an embodiment, the electronic device 101 may include displays 111 and 115, a distance adjusting unit 120, a processor 130, and memory 140. In an embodiment, the displays 111 and 115 may collectively be referred to as a display system 110.

In an embodiment, the displays 111 and 115 may include a liquid crystal display (LCD), and/or a plurality of light emitting diodes (LEDs). The LED of the displays 111 and 115 may include an organic LED (OLED). In an embodiment, the LED of the displays 111 and 115 may include a micro LED.

In an embodiment, at least one of the displays 111 and 115 may be a transparent display having a certain transmission rate (e.g., equal to or greater than 30%). Herein, the transmission rate may indicate a ratio of light, among external light incident on the display, that passes through the display.

In an embodiment, the displays 111 and 115 may be disposed spaced apart in the electronic device 101 (or in a housing of the electronic device 101). For example, the displays 111 and 115 may be spaced apart in a direction (or a depth direction) (or a thickness direction) perpendicular to a screen of each of the displays 111 and 115. For example, the display 111 may be configured to emit light toward a front surface. For example, the display 115 may be disposed spaced apart from the front surface of the display 111. For example, a rear surface of the display 115 may face the front surface of the display 111. In an embodiment, front surfaces of the displays 111 and 115 may indicate surfaces of areas in which screens are displayed.

In an embodiment, the displays 111 and 115 may have the same size as each other. However, the embodiment is not limited thereto. For example, the display 115 disposed at the front may have a smaller size than the display 111.

For example, the display 115 may be configured to transmit light from the rear surface (e.g., light of the display 111) to the front surface (according to a designated transmission rate). For example, the display 115 having a designated transmission rate may be referred to as a transparent display. According to an embodiment, the display 111 may be an opaque display or a transparent display. For example, the display 111 may be an opaque display configured to block transmission of light from a rear surface. For example, the display 111 may be a transparent display configured to transmit light from the rear surface.

In an embodiment, the displays 111 and 115 may be coupled such that a distance spaced apart from each other is adjustable. In an embodiment, the displays 111 and 115 may be coupled such that the distance spaced apart from each other is adjustable through the distance adjusting unit 120.

In an embodiment, the distance adjusting unit 120 may be configured to adjust a distance between the displays 111 and 115. For example, the distance adjusting unit 120 may adjust the distance between the displays 111 and 115 between a first state and a second state. For example, the first state may be a state in which the distance adjusting unit 120 causes the distance between the displays 111 and 115 to have a maximum distance provided by the distance adjusting unit 120 (or a state in which the distance between the displays 111 and 115 does not increase any further). For example, the second state may be a state in which the distance adjusting unit 120 causes the distance between the displays 111 and 115 to have a minimum distance provided by the distance adjusting unit 120 (or a state in which the distance between the displays 111 and 115 does not decrease any further).

In an embodiment, the distance adjusting unit 120 may provide power that enables linear movement between the displays 111 and 115. For example, the distance adjusting unit 120 may be a linear actuator. For example, the distance adjusting unit 120 may be a linear actuator based on a mechanical device or a linear actuator based on an electronic device. However, the embodiment is not limited thereto. For example, the distance adjusting unit 120 may be a linear actuator based on pressure (e.g., hydraulic pressure or pneumatic pressure).

For example, the distance adjusting unit 120 may be a linear actuator based on fastening between a screw (e.g., a ball screw, a lead screw, or a pinion gear) and a nut (e.g., a ball nut or a lead nut) (or a rack gear). For example, the distance adjusting unit 120 may adjust the distance between the displays 111 and 115 as the nut moves linearly along an axis by rotational movement of the screw (e.g., rotational movement of the screw transmitted by a motor (e.g., a stepper motor or a servo motor)). However, the embodiment is not limited thereto. For example, the distance adjusting unit 120 may be a linear actuator based on fastening between a cam gear and a ram gear. For example, the distance adjusting unit 120 may be a linear actuator based on fastening between a belt and a pulley. For example, the distance adjusting unit 120 may adjust the distance between the displays 111 and 115 based on a linear motor.

In an embodiment, the processor 130 may include a hardware component for processing data based on one or more instructions. The hardware component for processing data may include, for example, an arithmetic and logic unit (ALU), a floating point unit (FPU), a field programmable gate array (FPGA), a central processing unit (CPU), and/or an application processor (AP). The number of processors 130 may be one or more. For example, the processor 130 may have a structure of a multi-core processor, such as a dual core, a quad core, or a hexa core.

In an embodiment, the memory 140 of the electronic device 101 may include a hardware component for storing data and/or instructions inputted to and/or outputted from the processor 130. The memory 140 may include, for example, volatile memory such as random-access memory (RAM) and/or non-volatile memory such as read-only memory (ROM). In an embodiment, the volatile memory may include at least one of dynamic RAM (DRAM), static RAM (SRAM), Cache RAM, or pseudo SRAM (PSRAM). In an embodiment, the non-volatile memory may include at least one of programmable ROM (PROM), erasable PROM (EPROM), electrically erasable PROM (EEPROM), flash memory, a hard disk, a compact disk, a solid state drive (SSD), or an embedded multi media card (eMMC).

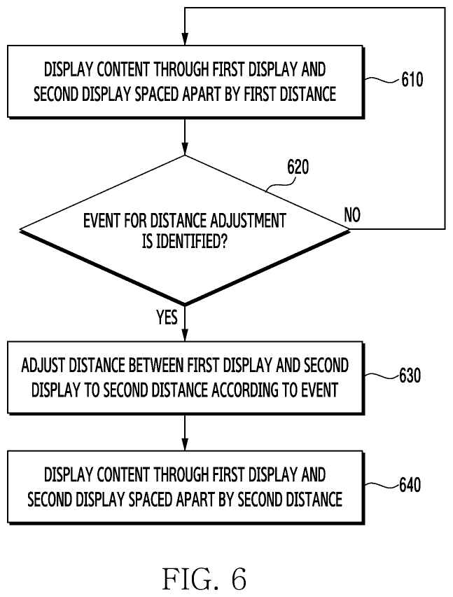

According to an embodiment, one or more instructions (or commands) indicating a computation and/or an operation to be performed on data by the processor 130 may be stored in the memory 140 of the electronic device 101. A set of one or more instructions may referred to as firmware, an operating system, a process, a routine, a sub-routine, and/or an application. For example, when a set of a plurality of instructions distributed in a form of an operating system, firmware, a driver, and/or an application is executed, the electronic device 101 and/or the processor 130 may perform at least one of operations of FIG. 6. Hereinafter, an application being installed on the electronic device 101 may mean that one or more instructions provided in a form of an application are stored in the memory 140 of the electronic device 101, and that the one or more applications are stored in a format (e.g., a file having an extension designated by an operating system of the electronic device 101) executable by the processor 130 of the electronic device 101.

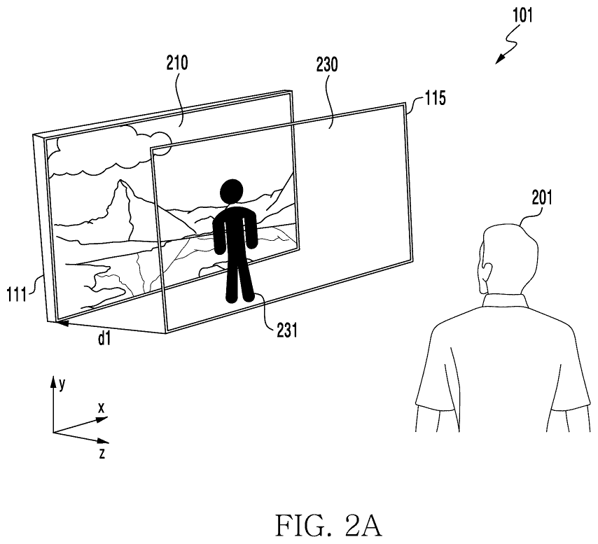

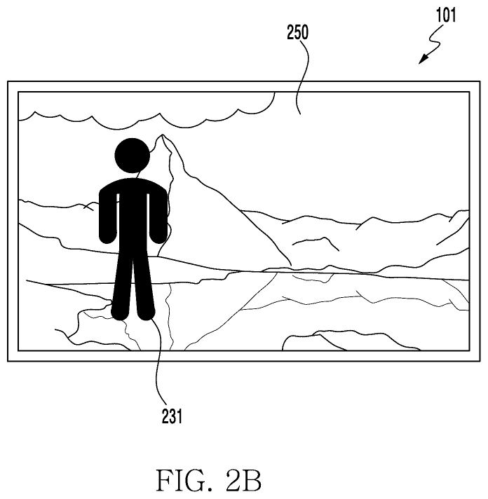

Hereinafter, with reference to FIGS. 2A, 2B, 3A, 3B, 4A-D, 5A, 5B to 5C, an operation in which the processor 130 of the electronic device 101 according to an embodiment adjusts the distance between the displays 111 and 115 through the distance adjusting unit 120 may be described.

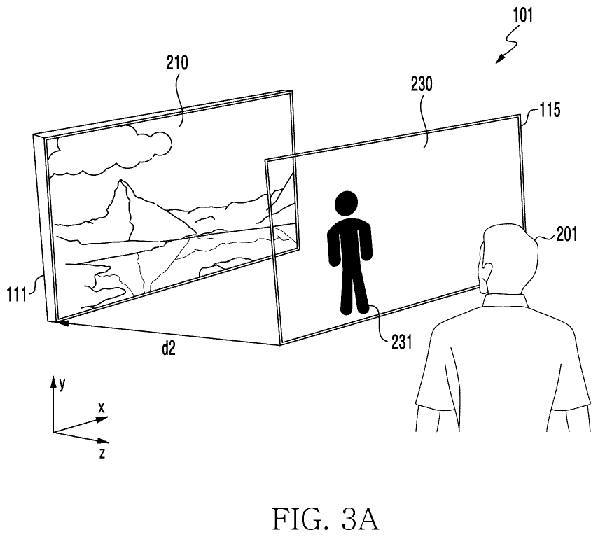

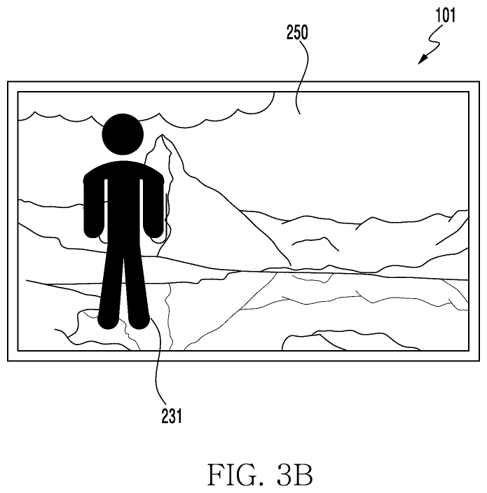

FIG. 2A is a perspective view of an electronic device in a state in which displays are spaced apart by a first distance, according to an embodiment. FIG. 2B is a diagram exemplifying a screen displayed by an electronic device in a state in which displays are spaced apart by a first distance, according to an embodiment. FIG. 3A is a perspective view of an electronic device in a state in which displays are spaced apart by a second distance, according to an embodiment. FIG. 3B is a diagram exemplifying a screen displayed by an electronic device in a state in which displays are spaced apart by a second distance, according to an embodiment.

FIGS. 2A, 2B, 3A to 3B may be described with reference to the electronic device 101 of FIG. 1.

In FIG. 2A, displays 111 and 115 of the electronic device 101 may be spaced apart from each other by a first distance d1. For example, the display 115 may be positioned at a position spaced apart by the first distance d1 from a front surface of the display 111. For example, the displays 111 and 115 may be spaced apart from each other by the first distance d1 along a depth direction (a z-axis direction).

In an embodiment, the electronic device 101 may display content through the displays 111 and 115. For example, the electronic device 101 may receive an input requesting playback of content. For example, the electronic device 101 may display the content through the displays 111 and 115 based on the input requesting playback of the content.

In an embodiment, the content may include two or more screens. For example, the content may include two or more screens arranged along the depth direction (the z-axis direction). For example, the content may include information on a distance between the two or more screens (hereinafter, distance information) as meta information. For example, the distance information may include information on distances between the two or more screens in each of playback sections of the content. For example, the content may include information on speed of adjusting the distance between the two or more screens (hereinafter, speed information) as meta information. For example, the speed information may include information on speed of adjusting the distances between the two or more screens in each of the playback sections of the content. For example, the content may include information on a layer of each of the two or more screens (hereinafter, layer information) as meta information. For example, the layer information may indicate an arrangement relationship of each of the screens. For example, the lowest layer may be a screen positioned furthest to the rear among the two or more screens. For example, the highest layer may be a screen positioned furthest to the front among the two or more screens. For example, when layer information of a first screen among the two or more screens indicates the lowest layer, the electronic device 101 may display the first screen through the rearmost display. For example, when layer information of a second screen among the two or more screens indicates the highest layer, the electronic device 101 may display the second screen through the frontmost display. For example, the content may include a first screen 210 and a second screen 230. For example, the content may include meta information including distance information, speed information, and/or layer information.

In an embodiment, the electronic device 101 may display the content through the displays 111 and 115 based on the distance information, the speed information, and/or the layer information.

For example, when the layer information indicates that the first screen 210 is the lowest layer and indicates that the second screen 230 is the highest layer, the electronic device 101 may display the first screen 210 on the display 111 positioned at the rear among the displays 111 and 115, and may display the second screen 230 on the display 115 positioned at the front among the displays 111 and 115. In an embodiment, as the electronic device 101 displays the first screen 210 on the display 111 and displays the second screen 230 on the display 115, a user 201 viewing the electronic device 101, as shown in FIG. 2B, may see a screen 250 in which the first screen 210 and the second screen 230 are overlapped.

For example, when the distance information indicates the first distance d1 between the first screen 210 and the second screen 230, the electronic device 101 may adjust the distance between the display 111 displaying the first screen 210 and the display 115 displaying the second screen 230 to the first distance d1 through a distance adjusting unit 120. For example, based on the speed information, when adjusting the distance between the display 111 and the display 115 to the first distance d1, the electronic device 101 may adjust relative movement speed of the display 115 with respect to the display 111 through the distance adjusting unit 120.

In an embodiment, the electronic device 101 may identify an event for changing the distance between the displays 111 and 115. For example, the electronic device 101 may identify an event for changing the distance while displaying the screens 210 and 230 through the displays 111 and 115 that are spaced apart by the first distance d1.

In an embodiment, the event may be an event triggered by an input. In an embodiment, the input may be a user input to the electronic device 101. In an embodiment, the input may be a user input for content displayed on the electronic device 101. For example, the input may be a user input for manipulating an object 231 displayed in the content. For example, the electronic device 101 may receive a user input from an external electronic device (or an input device (e.g., a remote controller, a keyboard, a mouse, a microphone, and/or a camera)) communicatively connected (wirelessly and/or wired). For example, the electronic device 101 may identify the user input as an event for changing the distance based on that the user input received from the external electronic device is a user input for the content. In an embodiment, the user input may include a gesture input identified through a camera. In an embodiment, the user input may include a voice input identified through a microphone.

For example, the electronic device 101 may receive a user input for manipulating the object 231 from the external electronic device. For example, when the content is content (e.g., a game or a browser) that may be manipulated by a user input, the electronic device 101 may receive a user input for manipulating the object 231 from the external electronic device. For example, the user input for manipulating the object 231 may include a user input for moving the object 231 in the depth direction (or in the z-axis direction). For example, the user input for manipulating the object 231 may include a user input for enlarging and/or reducing the object 231. For example, the electronic device 101 may identify the user input for moving the object 231 in the depth direction (or in the z-axis direction) received from the external electronic device as an event for changing the distance. For example, the electronic device 101 may identify the user input for enlarging and/or reducing the object 231 received from the external electronic device as an event for changing the distance. However, the embodiment is not limited thereto. For example, the electronic device 101 may identify a user input for enlarging and/or reducing an object within the screen 210 displayed on the display 111 distant from the user 201 as an event for changing the distance. For example, the electronic device 101 may receive a user input for moving the object within the first screen 210 in the depth direction (or in the z-axis direction). For example, the electronic device 101 may identify the user input for moving the object within the first screen 210 in the depth direction (or in the z-axis direction) as an event. For example, the electronic device 101 may adjust the distance between the displays 111 and 115 through the distance adjusting unit 120, as it identifies the event.

In an embodiment, based on that the user input is an input for enlarging the object 231, the electronic device 101 may adjust the distance between the displays 111 and 115 through the distance adjusting unit 120 such that the display 115 is moved away from the display 111. In an embodiment, based on that the user input is an input for reducing the object 231, the electronic device 101 may adjust the distance between the displays 111 and 115 through the distance adjusting unit 120 such that the display 115 is closer to the display 111.

In an embodiment, the event may be an event triggered by meta information. For example, the electronic device 101 may identify distance information on each of playback sections from the meta information. For example, the electronic device 101 may identify, as an event for changing the distance, that a distance according to distance information of a current playback section differs from a distance according to distance information of a next playback section. For example, as shown in Table 1 below, the distance information on each of the playback sections may be stored as the meta information of the content.

TABLE 1

| | Playback section | | |
|---|---|---|---|
| | Playback | Playback | Playback |
| | section 1 | section 2 | section 3 |
| Playback time point | “01:13:03” | “01:13:05” | “01:13:10” |
| Playback duration | “00:0:02” | “00:0:05” | “00:0:03” |
| Position 1 | “0” | “0” | “0” |
| Position 2 | “0.3” | “0.3” | “1” |
| Distance | “0.3” | “0.3” | “1” |
| Change speed | “0.1” | “0” | “0.2” |

For example, the playback section included in the meta information may indicate an order (or a sequence) of each of the playback sections. For example, the playback time point included in the meta information may indicate a timestamp for the playback time point of the content. For example, the playback duration included in the meta information may indicate a time length of a specific playback section. For example, the meta information may indicate a position of each of screens. For example, the position of each of the screens may indicate a distance from a reference screen (e.g., the rearmost screen). For example, the position 1 may indicate a position of the rearmost screen. For example, the position 2 may indicate a position of the frontmost screen. For example, the meta information may indicate a distance of each of the screens. For example, the distance of each of the screens may indicate a positional difference between two consecutive screens. For example, the distance may indicate a positional difference between a screen 1 (e.g., the rearmost screen 111) and a screen 2 (e.g., the frontmost screen 115). For example, the meta information may indicate speed of changing the distance of each of the screens. For example, the speed of changing the distance of each of the screens may indicate operating speed of the distance adjusting unit 120.

For example, referring to Table 1, the electronic device 101 may not change the distance between the displays 111 and 115 through the distance adjusting unit 120 when changing from the playback section 1 to the playback section 2, based on that the distance (“0.3”) according to distance information of the playback section 1 and the distance (“0.3”) according to distance information of the playback section 2 is the same. For example, referring to Table 1, the electronic device 101 may change the distance between the displays 111 and 115 through the distance adjusting unit 120 when changing from the playback section 2 to the playback section 3, based on that the distance (“0.3”) according to the distance information of the playback section 2 and the distance (“1”) according to the distance information of the playback section 3 are different. Although the meta information is exemplified as shown in Table 1 above, this is merely an example. For example, the meta information may be data written in a designated format. For example, the meta information may be data written in a designated format through a markup language.

In an embodiment, as the electronic device 101 identifies an event for changing the distance, it may change (or adjust) the distance between the displays 111 and 115 through the distance adjusting unit 120. For example, the electronic device 101 may change (or adjust) the distance between the displays 111 and 115 from the first distance d1 to a second distance d2 through the distance adjusting unit 120.

For example, when the distance between the displays 111 and 115 is changed from the first distance d1 to the second distance d2 according to an event triggered by an input, the second distance d2 may be determined based on the input. In an embodiment, the electronic device 101 may determine the second distance d2 based on a length of the input, a type of the input, and/or a distance indicated by the input. In an embodiment, the length of the input may indicate a time length in which the input lasts. In an embodiment, the type of the input may be input events (e.g., a press, a long-press, or a double-press of a button (e.g., a keyboard or a remote controller)) distinguished by each input device. For example, in a case of a mouse, the type of the input may be a click and/or a double click. However, the embodiment is not limited thereto. For example, in a case of touch-sensitive circuitry, the type of the input may be a press, a long-press, or a double-press.

For example, the electronic device 101 may determine a distance corresponding to the length of the input as the second distance d2. For example, when the input is an input for increasing the distance between the displays 111 and 115, the electronic device 101 may determine the second distance d2 such that the distance between the displays 111 and 115 increases as the length of the input increases. For example, when the input is an input for decreasing the distance between the displays 111 and 115, the electronic device 101 may determine the second distance d2 such that the distance between the displays 111 and 115 decreases as the length of the input increases.

For example, the electronic device 101 may determine a distance corresponding to the type of the input as the second distance d2. For example, when the type of the input is a first input (e.g., an input indicating a first gesture), the electronic device 101 may determine a distance corresponding to the first input as the second distance d2. For example, when the type of the input is a second input (e.g., an input indicating a second gesture), the electronic device 101 may determine a distance corresponding to the second input as the second distance d2. For example, the first input (e.g., the input indicating the first gesture) may be a different type of input from the second input (e.g., the input indicating the second gesture). The distance assigned to the first input (e.g., the input indicating the first gesture) may be different from the distance assigned to the second input (e.g., the input indicating the second gesture).

For example, the electronic device 101 may determine the distance indicated by the input as the second distance d2. For example, in a case of a voice input, the electronic device 101 may determine a distance indicated by the voice input (e.g., “Set the distance between the displays 111 and 115 to a specific distance”) as the second distance d2.

For example, when the distance between the displays 111 and 115 is changed from the first distance d1 to the second distance d2 according to an event triggered by the meta information, the second distance d2 may be determined based on the meta information. For example, the electronic device 101 may determine the second distance d2 based on distances of each of the playback sections, based on meta information such as Table 1.

In an embodiment, as the electronic device 101 identifies an event for changing the distance, it may change (or adjust) the distance between the displays 111 and 115 at designated speed through the distance adjusting unit 120. For example, when the distance between the displays 111 and 115 is changed from the first distance d1 to the second distance d2 according to an event triggered by an input, the designated speed may be determined based on the input. In an embodiment, the electronic device 101 may determine the designated speed for changing (or adjusting) the distance between the displays 111 and 115 through the distance adjusting unit 120, based on a length of the input, a type of the input, and/or a distance indicated by the input.

For example, when the distance between the displays 111 and 115 is changed from the first distance d1 to the second distance d2 according to an event triggered by the meta information, the designated speed may be determined based on the meta information. For example, the electronic device 101 may determine speed set in each of the playback sections as the designated speed for changing (or adjusting) the distance between the displays 111 and 115 through the distance adjusting unit 120, based on the meta information such as Table 1.

In an embodiment, the electronic device 101 may maintain sizes of objects within screens displayed through the displays 111 and 115 while adjusting the distance between the displays 111 and 115 through the distance adjusting unit 120. For example, the electronic device 101 may maintain sizes of objects included in the screen 210 and/or the screen 230 while enlarging or reducing the distance between the display 111 and the display 115 through the distance adjusting unit 120. For example, the electronic device 101 may maintain a size of the object 231 within the second screen 230 while enlarging or reducing the distance between the display 111 and the display 115 through the distance adjusting unit 120. For example, referring to FIG. 3A, the electronic device 101 may maintain the size of the object 231 within the second screen 230 while enlarging the distance between the display 111 and the display 115 from the first distance d1 to the second distance d2 through the distance adjusting unit 120. Accordingly, the electronic device 101 may provide the user 201 with a depth perception experience that is felt as a physical distance becomes closer, without changing the size of the object 231 displayed on the display 115.

In an embodiment, the electronic device 101 may change the sizes of the objects within the screens displayed through the displays 111 and 115 after adjusting the distance between the displays 111 and 115 through the distance adjusting unit 120. For example, when the distance between the displays 111 and 115 reaches a maximum distance, the electronic device 101 may change the sizes of the objects within the screens displayed through the displays 111 and 115. For example, when the distance between the displays 111 and 115 reaches the maximum distance, the electronic device 101 may enlarge a size of an object within a screen displayed on the display 115 adjacent to the user 201. For example, when the distance between the displays 111 and 115 reaches the maximum distance, the electronic device 101 may reduce a size of an object within a screen displayed on the display 111 distant from the user 201.

For example, when the distance between the displays 111 and 115 reaches a minimum distance, the electronic device 101 may change the sizes of the objects within the screens displayed through the displays 111 and 115. For example, when the distance between the displays 111 and 115 reaches the minimum distance, the electronic device 101 may reduce the size of an object within the screen displayed on the display 115 adjacent to the user 201. For example, when the distance between the displays 111 and 115 reaches the minimum distance, the electronic device 101 may enlarge the size of an object within the screen displayed on the display 111 distant from the user 201.

In an embodiment, the electronic device 101 may display the content through the displays 111 and 115 adjusted to the second distance d2. In an embodiment, as the electronic device 101 displays the first screen 210 and the second screen 230 through the displays 111 and 115 adjusted to the second distance d2, the user 201 viewing the electronic device 101, as shown in FIG. 3B, may see the screen 250 in which the first screen 210 and the second screen 230 are overlapped. In FIG. 3B, compared to FIG. 2B, even when the distance between the displays 111 and 115 is increased to the second distance d2, the size of the object 231 within the screen 230 is maintained, but as the distance between the user 201 and the object 231 is decreased, the user 201 may perceive that the size of the object 231 seen by the user 201 in FIG. 3B is larger than the size of the object 231 seen by the user 201 in FIG. 2B.

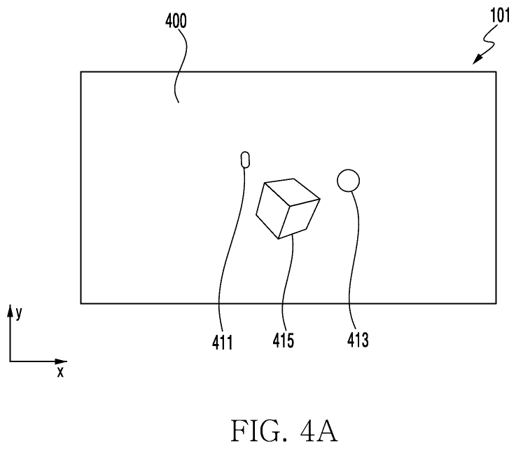

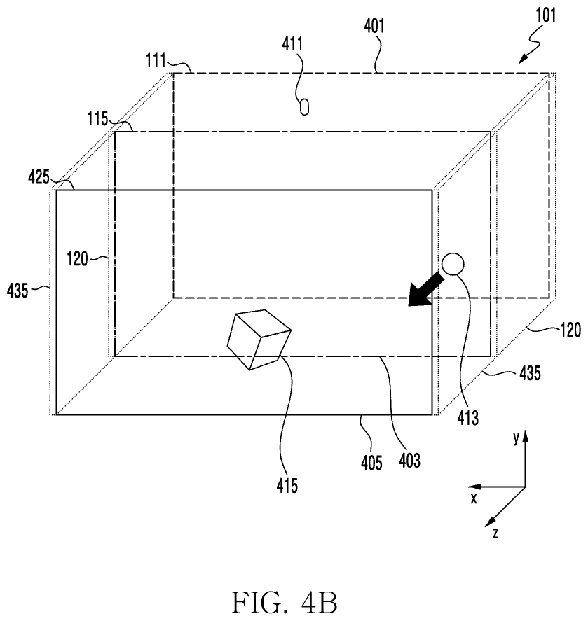

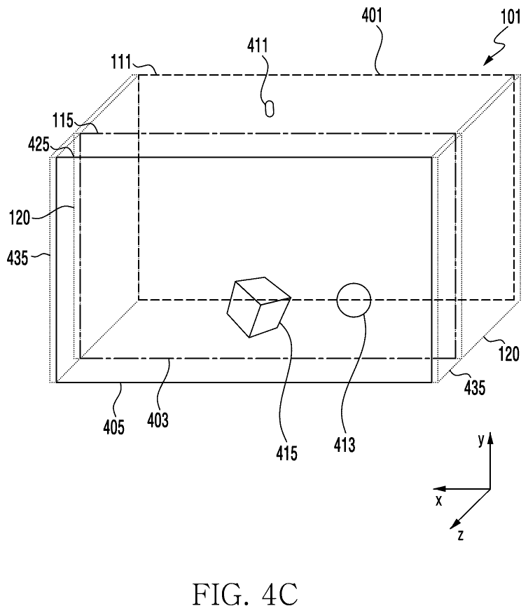

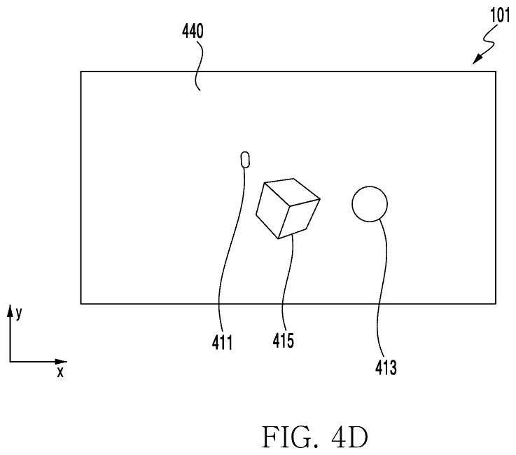

FIG. 4A is a diagram exemplifying a screen in which screens displayed by displays of an electronic device are overlapped, according to an embodiment. FIG. 4B is a perspective view of an electronic device in a state in which displays are spaced apart by specific distances, according to an embodiment. FIG. 4C is a perspective view of an electronic device in a state in which displays are spaced apart by other specific distances, according to an embodiment. FIG. 4D is a diagram exemplifying another screen in which screens displayed by displays of an electronic device are overlapped, according to an embodiment.

FIGS. 4A to 4D may be described with reference to the electronic device 101 of FIG. 1. Descriptions of FIGS. 4A to 4D may refer to the description of the electronic device 101 based on FIGS. 2A to 3B.

Referring to FIG. 4A, the electronic device 101 may provide an overlapped screen 400 to a user. For example, the overlapped screen 400 may depict a state in which screens displaying different objects 411, 413, and 415 are overlapped.

For example, in FIG. 4B, the electronic device 101 may include three or more displays 111, 115, and 425. The three or more displays 111, 115, and 425 may be spaced apart from each other. For example, the three or more displays 111, 115, and 425 may be spaced apart from each other along a depth direction (a z-axis direction). Hereinafter, a distance between the displays 111 and 115 may be referred to as a first distance. A distance between the displays 115 and 425 may be referred to as a second distance. A distance between the displays 111 and 425 may be referred to as a third distance.

In an embodiment, the display 425 may include an LCD and/or a plurality of LEDs. The LED of the display 425 may include OLED and/or micro LED.

In an embodiment, the display 425 may be a transparent display having a certain transmission rate (e.g., equal to or greater than 30%). For example, the transmission rate of the display 425 may be equal to or greater than a transmission rate of the display 115.

In an embodiment, the display 425 may be disposed spaced apart from a front surface of the display 115. For example, a rear surface of the display 425 may face the front surface of the display 115. In an embodiment, a front surface of the display 425 may indicate a surface of an area in which a screen is displayed.

In an embodiment, the display 425 may have the same size as the displays 111 and 115. However, the embodiment is not limited thereto. For example, the display 425 disposed at the front may have a smaller size than the display 115.

In an embodiment, the displays 115 and 425 may be coupled such that a distance spaced apart from each other is adjustable. In an embodiment, the displays 115 and 425 may be coupled such that the distance spaced apart from each other is adjustable through a distance adjusting unit 435.

In an embodiment, the distance adjusting unit 435 may be configured to adjust the distance between the displays 115 and 425. For example, the distance adjusting unit 435 may adjust the distance between the displays 115 and 425 between a first state and a second state. For example, the first state may be a state in which the distance adjusting unit 435 has a maximum distance between the displays 115 and 425 provided by the distance adjusting unit 435 (or a state in which the distance between the displays 115 and 425 does not increase any further). For example, the second state may be a state in which the distance adjusting unit 435 has a minimum distance between the displays 115 and 425 provided by the distance adjusting unit 435 (or a state in which the distance between the displays 115 and 425 does not decrease any further).

In an embodiment, the distance adjusting unit 435 may provide power that enables linear movement between the displays 115 and 425. For example, the distance adjusting unit 435 may be a linear actuator. For example, the distance adjusting unit 435 may be a linear actuator based on a mechanical device or a linear actuator based on an electronic device. However, the embodiment is not limited thereto. For example, the distance adjusting unit 435 may be a linear actuator based on pressure (e.g., hydraulic pressure or pneumatic pressure).

In an embodiment, the electronic device 101 may display content through the displays 111, 115, and 425. For example, the electronic device 101 may receive an input requesting playback of content. For example, the electronic device 101 may display the content through the displays 111, 115, and 425 based on the input requesting playback of the content.

In an embodiment, the content may include three or more screens. In an embodiment, the content may include the number of screens corresponding to the number of the displays 111, 115, and 425. For example, the content may include three or more screens arranged along the depth direction (the z-axis direction). For example, the content may include information on a distance between the three or more screens (hereinafter, distance information) as meta information. For example, the distance information may include information on distances between the three or more screens in each of playback sections of the content. For example, the content may include information on speed of adjusting the distance between the three or more screens (hereinafter, speed information) as meta information. For example, the speed information may include information on speed of adjusting the distances between the three or more screens in each of the playback sections of the content. For example, the content may include information on a layer of each of the three or more screens (hereinafter, layer information) as meta information. For example, the layer information may indicate an arrangement relationship of each of the screens. For example, the content may include a first screen 401, a second screen 403, and a third screen 405. For example, the content may include meta information including distance information, speed information, and/or layer information.

In an embodiment, the electronic device 101 may display the content through the displays 111, 115, and 425 based on the distance information, the speed information, and/or the layer information.

For example, when the layer information indicates that the first screen 401 is the lowest layer, indicates that the second screen 403 is a middle layer, and indicates that the third screen 405 is the highest layer, the electronic device 101 may display the first screen 401 on the display 111 positioned at the rear among the displays 111, 115, and 425, display the second screen 403 on the display 115 positioned in the middle among the displays 111, 115, and 425, and display the third screen 405 on the display 425 positioned at the front among the displays 111, 115, and 425. In an embodiment, as the electronic device 101 displays the first screen 401 on the display 111, displays the second screen 403 on the display 115, and displays the third screen 405 on the display 425, the user viewing the electronic device 101, as shown in FIG. 4A, may see the screen 400 in which the screens 401, 403, and 405 are overlapped.

In an embodiment, the electronic device 101 may identify an event for changing a distance between the displays 111, 115, and 425. In an embodiment, the event may be an event triggered by an input. In an embodiment, the event may be an event triggered by meta information as shown in Table 2 below.

TABLE 2

| | Playback section | | |
|---|---|---|---|
| | Playback | Playback | Playback |
| | section 1 | section 2 | section 3 |
| Playback time point | “01:13:03” | “01:13:05” | “01:13:10” |
| Playback duration | “00:0:02” | “00:0:05” | “00:0:03” |
| Position 1 | “0” | “0” | “0” |
| Position 2 | “0.3” | “0.4” | “0.8” |
| Position 3 | “0.5” | “0.5” | “1” |
| Distance 1 | “0.3” | “0.4” | “0.8” |
| Distance 2 | “0.2” | “0.1” | “0.2” |
| Distance 3 | “0.5” | “0.8” | “1” |
| Change speed 1 | “0.1” | “0.1” | “0.2” |
| Change speed 2 | “0” | “0.3” | “0.2” |

For example, the playback section included in the meta information may indicate an order (or a sequence) of each of the playback sections. For example, the playback time point included in the meta information may indicate a timestamp for the playback time point of the content. For example, the playback duration included in the meta information may indicate a time length of a specific playback section. For example, the meta information may indicate a position of each of screens. For example, the position of each of the screens may indicate a distance from a reference screen (e.g., the rearmost screen). For example, the position 1 may indicate a position of the rearmost screen. For example, the position 2 may indicate a position of the middle screen. For example, the position 3 may indicate a position of the frontmost screen. For example, the meta information may indicate a distance of each of the screens. For example, the distance of each of the screens may indicate a positional difference between two consecutive screens. For example, the distance 1 may indicate a positional difference between a screen 1 (e.g., the rearmost screen 111) and a screen 2 (e.g., the middle screen 115). For example, the distance 2 may indicate a positional difference between the screen 2 and a screen 3 (e.g., the frontmost screen 425). For example, the distance 3 may indicate a positional difference between the screen 1 and the screen 3. For example, the meta information may indicate speed of changing the distance of each of the screens. For example, the speed of changing the distance of each of the screens may indicate operating speed of distance adjusting units 120 and 435. For example, the change speed 1 may indicate operating speed of the distance adjusting unit 120 related to the distance 1. For example, the change speed 2 may indicate operating speed of the distance adjusting unit 435 related to the distance 2.

For example, referring to Table 2, the electronic device 101 may change the distance between the displays 111 and 115 through the distance adjusting unit 120 when changing from the playback section 1 to the playback section 2, based on that the distance 1 (“0.3”) according to distance information of the playback section 1 and the distance 1 (“0.4”) according to distance information of the playback section 2 are different. For example, referring to Table 2, the electronic device 101 may change the distance between the displays 115 and 425 through the distance adjusting unit 435 when changing from the playback section 1 to the playback section 2, based on that the distance 2 (“0.5”) according to the distance information of the playback section 1 and the distance 2 (“0.8”) according to the distance information of the playback section 2 are different. For example, in FIGS. 4B and 4C, the electronic device 101 may change the distance between the displays 111, 115, and 425 such that the object 413 within the second screen 403 moves in the depth direction.

In an embodiment, when moving one display among the displays 111, 115, and 425, the electronic device 101 may maintain a distance between other displays among the displays 111, 115, and 425. For example, when moving the display 115 toward the display 425, the electronic device 101 may control the distance adjusting units 120 and 435 such that the distance between the display 425 and the display 111 is maintained. For example, the electronic device 101 may adjust the distance between the display 111 and the display 115 through the distance adjusting unit 120 such that the distance between the display 111 and the display 425 is maintained while adjusting the distance between the display 115 and the display 425 through the distance adjusting unit 435.

In an embodiment, the electronic device 101 may maintain sizes of the objects 411, 413, and 415 within the screens 401, 403, and 405 displayed through the displays 111, 115, and 425 while adjusting the distance between the displays 111, 115, and 425 through the distance adjusting unit 120. For example, the electronic device 101 may maintain the sizes of the objects 411, 413, 415 included in the screen 401, the screen 403, and/or the screen 405 while enlarging or reducing the distance between the display 111 and the display 115 through the distance adjusting unit 120. For example, referring to FIG. 4C, the electronic device 101 may maintain the sizes of the objects 411, 413, and 415 within the screens 401, 403, and 405 while controlling the distance adjusting unit 435 such that the distance between the display 115 and the display 425 becomes smaller. Accordingly, the electronic device 101 may provide a user 201 with a depth perception experience that is felt as a physical distance becomes closer, without changing the size of the object 413 displayed on the display 425.

In an embodiment, the electronic device 101 may change the sizes of the objects 411, 413, and 415 within the screens 401, 403, and 405 displayed through the displays 111, 115, and 425 after adjusting the distance between the displays 111, 115, and 425 through the distance adjusting unit 120. For example, when each of the distances between the displays 111, 115, and 425 reaches a maximum distance, the electronic device 101 may change the sizes of the objects 411, 413, and 415 within the screens 401, 403, 405 displayed through the displays 111, 115, and 425. For example, when each of the distances between the displays 111, 115, 425 reaches a minimum distance, the electronic device 101 may change the sizes of the objects 411, 413, and 415 within the screens 401, 403, and 405 displayed through the displays 111, 115, and 425.

In an embodiment, as the electronic device 101 displays the screens 401, 403, and 405 through the displays 111, 115, and 425 with adjusted distances, the user 201 viewing the electronic device 101, as shown in FIG. 4D, may see a screen 440 in which the screens 401, 403, and 405 are overlapped. The object 413 within the screen 440 in FIG. 4D may be viewed larger to the user as it becomes relatively closer to the user compared to the screen 400 of FIG. 4A. However, the objects 411 and 415 within the screen 440 of FIG. 4D may be viewed as the same to the user, as a relative distance to the user is maintained compared to the screen 400 of FIG. 4A.

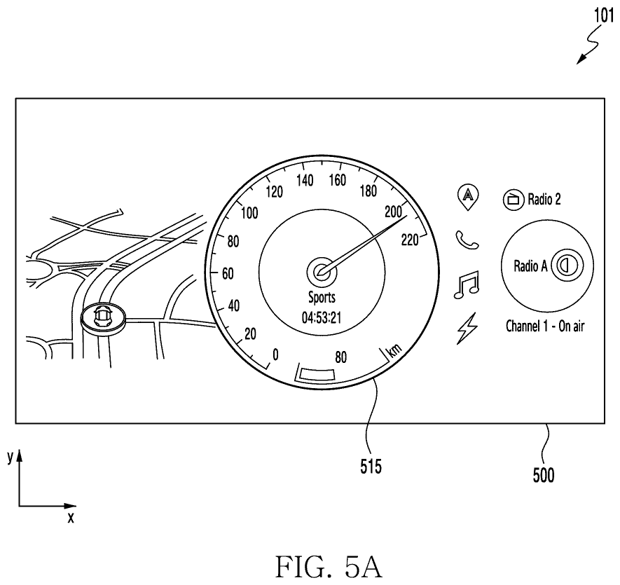

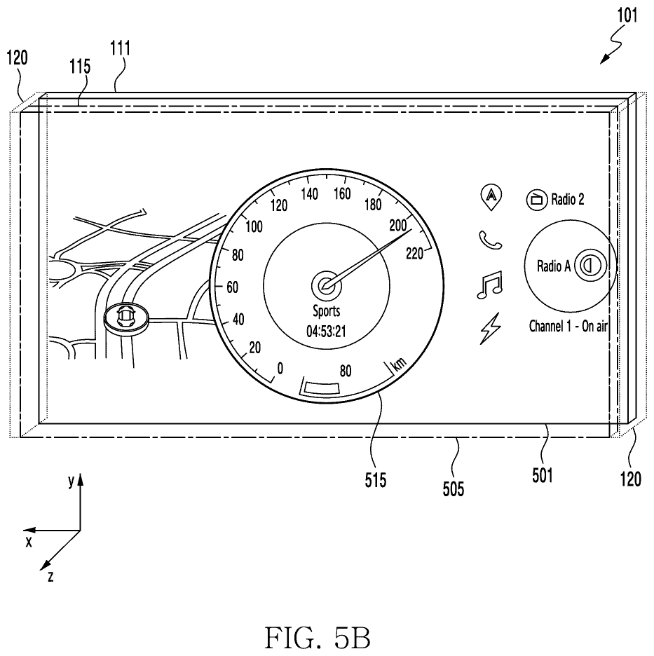

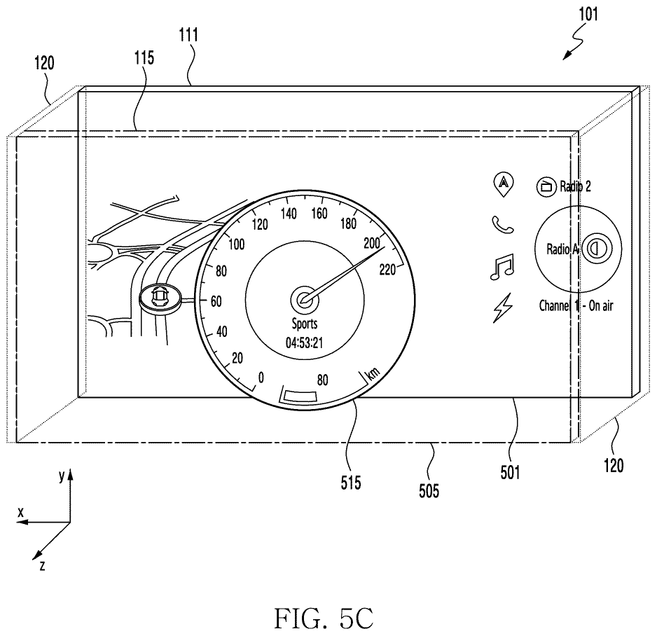

FIG. 5A is a diagram exemplifying a screen in which screens displayed by displays of an electronic device are overlapped, according to an embodiment. FIG. 5B is a perspective view of an electronic device in a state in which displays are spaced apart by a specific distance, according to an embodiment. FIG. 5C is a perspective view of an electronic device in a state in which displays are spaced apart by another specific distance, according to an embodiment.

FIGS. 5A to 5C may be described with reference to the electronic device 101 of FIG. 1. Descriptions of FIGS. 5A to 5C may refer to the description of the electronic device 101 based on FIGS. 2A to 4D.

Referring to FIG. 5A, the electronic device 101 may provide an overlapped screen 500 to a user. For example, the overlapped screen 500 may depict a state in which screens displaying different objects 515 are overlapped. In an embodiment, the electronic device 101 may be a display device for a vehicle. For example, the electronic device 101 may be a display device mounted on a instrument panel or a center fascia of the vehicle.

For example, in FIG. 5B, the electronic device 101 may include two or more displays 111 and 115. The two or more displays 111 and 115 may be spaced apart from each other. For example, the two or more displays 111 and 115 may be spaced apart from each other along a depth direction (a z-axis direction).

In an embodiment, the electronic device 101 may display content through the displays 111 and 115. For example, the electronic device 101 may receive an input requesting playback of content. For example, the electronic device 101 may display the content through the displays 111 and 115 based on the input requesting playback of the content. For example, the input requesting playback of the content may include an input to turn-on the electronic device 101 (e.g., an input for starting the vehicle on which the electronic device 101 is mounted).

In an embodiment, the content may include two or more screens. In an embodiment, the content may include the number of screens corresponding to the number of the displays 111 and 115. For example, the content may include two or more screens arranged along the depth direction (the z-axis direction).

For example, the electronic device 101 may display a first screen 501 on the display 111 positioned at the rear among the displays 111 and 115, and may display a second screen 505 on the display 115 positioned at the front among the displays 111 and 115. In an embodiment, as the electronic device 101 displays the first screen 501 on the display 111 and the second screen 505 on the display 115, the user viewing the electronic device 101, as shown in FIG. 5A, may see the screen 500 in which the screens 501 and 505 are overlapped.

In an embodiment, the electronic device 101 may identify an event for changing a distance between the displays 111 and 115. In an embodiment, the event may be an event triggered by an input. In an embodiment, the input may include a direct input to the electronic device 101 and/or an indirect input to the electronic device 101. In an embodiment, the indirect input to the electronic device 101 may include an input to the vehicle on which the electronic device 101 is mounted (e.g., an input to a pedal (e.g., an accelerator pedal or a brake pedal), an input to an infotainment system of the vehicle, or an input to a convenience device (e.g., an air conditioning system) of the vehicle).

For example, in FIGS. 5B and 5C, the electronic device 101 may change the distance between the displays 111 and 115 such that the object 515 within the second screen 505 moves in the depth direction. For example, the electronic device 101 may change the distance between the displays 111 and 115 such that the screen 505 displaying the object 515 indicating an instrument panel moves in the depth direction, based on the input to the pedal (e.g., the accelerator pedal or the brake pedal).

In an embodiment, the electronic device 101 may maintain sizes of the objects 515 within the screens 501 and 505 displayed through the displays 111 and 115 while adjusting the distance between the displays 111 and 115 through a distance adjusting unit 120.

In an embodiment, the electronic device 101 may change the sizes of the objects 515 within the screens 501 and 505 displayed through the displays 111 and 115 after adjusting the distance between the displays 111 and 115 through the distance adjusting unit 120. For example, when each of the distances between the displays 111 and 115 reaches a maximum distance, the electronic device 101 may change the sizes of the objects 515 within the screens 501 and 505 displayed through the displays 111 and 115. For example, when each of the distances between the displays 111 and 115 reaches a minimum distance, the electronic device 101 may change the sizes of the objects 515 within the screens 501 and 505 displayed through the displays 111 and 115.

In an embodiment, as the electronic device 101 displays the screens 501 and 505 through the displays 111 and 115 with adjusted distances, a user 201 viewing the electronic device 101 may see a screen in which the screens 501 and 505 are overlapped. The object 515 may be viewed larger to the user as it becomes relatively closer to the user compared to the screen 500 of FIG. 5A.

FIG. 6 is a flowchart indicating an operation of an electronic device according to an embodiment.

FIG. 6 may be described with reference to FIGS. 1 to 5C.

Referring to FIG. 6, in operation 610, an electronic device 101 may display content through a first display 111 and a second display 115 spaced apart by a first distance. For example, the display 115 may be positioned at a position spaced apart by a first distance d1 from a front surface of the display 111. For example, the displays 111 and 115 may be spaced apart from each other by the first distance d1 along a depth direction (a z-axis direction).

For example, the electronic device 101 may obtain an input requesting playback of content. For example, the electronic device 101 may display the content through the displays 111 and 115 based on the input requesting playback of the content.

For example, the electronic device 101 may display a first screen 210 having the lowest layer on the display 111 positioned at the rear among the displays 111 and 115, and display a second screen 230 having the highest layer on the display 115 positioned at the front of the displays 111 and 115. In an embodiment, as the electronic device 101 displays the first screen 210 on the display 111 and displays the second screen 230 on the display 115, a user 201 viewing the electronic device 101 may see a screen 250 in which the first screen 210 and the second screen 230 are overlapped.

In operation 620, the electronic device 101 may determine whether an event for distance adjustment is identified.

In an embodiment, the event may be an event triggered by an input. In an embodiment, the input may be a user input (direct or indirect) to the electronic device 101. In an embodiment, the input may be a user input for the content displayed on the electronic device 101. For example, the electronic device 101 may receive a user input from an external electronic device (or an input device (e.g., a remote controller, a keyboard, a mouse, a microphone, and/or a camera)) communicatively connected (wirelessly and/or wired). For example, the electronic device 101 may identify the user input as an event for changing the distance based on that the user input received from the external electronic device is a user input for the content.

For example, the user input may include a user input for manipulating an object 231 in the content. For example, the user input for manipulating the object 231 may include a user input for moving the object 231 in the depth direction (or in the z-axis direction). For example, the user input for manipulating the object 231 may include a user input for enlarging and/or reducing the object 231.

In an embodiment, the event may be an event triggered by meta information. For example, the electronic device 101 may identify distance information on each of playback sections from the meta information. For example, the electronic device 101 may identify, as an event for changing the distance, that a distance according to distance information of a current playback section differs from a distance according to distance information of a next playback section.

In operation 630, the electronic device 101 may adjust the distance between the first display 111 and the second display 115 to a second distance according to the event.

For example, the electronic device 101 may determine a second distance d2 according to an event triggered by an input, based on the input. For example, the electronic device 101 may determine the second distance d2 based on a length of the input, a type of the input, and/or a distance indicated by the input. For example, the electronic device 101 may determine a distance corresponding to the length of the input as the second distance d2. For example, the electronic device 101 may determine the second distance d2 according to an event triggered by the input, based on the type of the input. For example, when the type of the input is a first input (e.g., an input indicating a first gesture), the electronic device 101 may determine a distance corresponding to the first input as the second distance d2. For example, when the type of the input is a second input (e.g., an input indicating a second gesture), the electronic device 101 may determine a distance corresponding to the second input as the second distance d2. For example, the electronic device 101 may determine the second distance d2 according to an event triggered by the input as the distance indicated by the input. For example, in a case of a voice input, the electronic device 101 may determine a distance indicated by the voice input (e.g., “Set the distance between the displays 111 and 115 to a specific distance”) as the second distance d2. However, the embodiment is not limited thereto. For example, the electronic device 101 may determine the second distance d2 according to an event triggered by the input, based on meta information.

In an embodiment, the electronic device 101 may change (or adjust) the distance between the displays 111 and 115 at designated speed through a distance adjusting unit 120 to have the second distance d2 determined according to the event for changing the distance.

In operation 640, the electronic device 101 may display the content through the first display 111 and the second display 115 spaced apart by the second distance. In an embodiment, the electronic device 101 may display the content through the first display 111 and the second display 115 while the distance is being adjusted from the first distance to the second distance. In an embodiment, the electronic device 101 may display the content through the first display 111 and the second display 115 after the distance is adjusted from the first distance to the second distance.

In an embodiment, the electronic device 101 may maintain sizes of objects within screens displayed through the displays 111 and 115 while adjusting the distance between the displays 111 and 115 through the distance adjusting unit 120. In an embodiment, the electronic device 101 may change the sizes of the objects within the screens displayed through the displays 111 and 115 after adjusting the distance between the displays 111 and 115 through the distance adjusting unit 120.

As described above, the electronic device 101 may provide a screen with a sense of depth to the user through two or more displays 111 and 115 arranged in the depth direction (or a thickness direction) (or the z-axis direction). In addition, the electronic device 101 may provide the user with an effect in which the object within the screen is viewed larger to the user by adjusting the distance between the displays 111 and 115 without changing the size of the object within the screen displayed through the displays 111 and 115. Accordingly, user experience of experiencing three dimensional (3D) content through the two or more displays 111 and 115 arranged in the depth direction (or the thickness direction) (or the z-axis direction) may be enhanced.

The technical problems to be achieved in the present disclosure are not limited to those described above, and other technical problems not mentioned herein will be clearly understood by those skilled in the art to which the present disclosure belongs.

As described above, an electronic device 101 may comprise a first display 111 configured to emit light toward a front surface, a second display 115 disposed in front of the front surface of the first display 111 and configured to transmit light from a rear surface to a front surface, a distance adjusting unit 120 configured to change a distance between the first display 111 and the second display 115, at least one processor 130 comprising processing circuitry, and memory 140 comprising one or more storage mediums storing instructions. The instructions, when executed by the at least one processor 130 individually or collectively, may cause the electronic device 101 to display a first screen 210 through the first display 111, display a second screen 230 through the second display 115, identify an event for changing the distance, and according to identifying the event, adjust, through the distance adjusting unit 120, the distance between the first display 111 and the second display 115.

The instructions, when executed by the at least one processor 130 individually or collectively, may cause the electronic device 101 to receive a user input for moving an object 231 within the second screen 230 in a depth direction perpendicular to the second screen 230, and identify the user input for moving the object 231 within the second screen 230 as the event.

The instructions, when executed by the at least one processor 130 individually or collectively, may cause the electronic device 101 to, based on that the user input is an input for enlarging the object 231, adjust the distance between the second display 115 and the first display 111 through the distance adjusting unit 120 such that the second display 115 is moved away from the first display 111, and based on that the user input is an input for reducing the object 231, adjust the distance between the second display 115 and the first display 111 through the distance adjusting unit 120 such that the second display 115 is closer to the first display 111.

The instructions, when executed by the at least one processor 130 individually or collectively, may cause the electronic device 101 to maintain a size of the object 231 within the second screen 230 while adjusting the distance through the distance adjusting unit 120.

The instructions, when executed by the at least one processor 130 individually or collectively, may cause the electronic device 101 to, based on that the user input is an input for enlarging the object 231, adjust the distance through the distance adjusting unit 120 such that the distance increases, and based on that the distance reaches a maximum distance, enlarge the size of the object 231 within the second screen 230.

The instructions, when executed by the at least one processor 130 individually or collectively, may cause the electronic device 101 to, based on that the user input is an input for reducing the object 231, adjust the distance through the distance adjusting unit 120 such that the distance decreases, and based on that the distance reaches a minimum distance, reduce the size of the object 231 within the second screen 230.

The instructions, when executed by the at least one processor 130 individually or collectively, may cause the electronic device 101 to receive another input for moving another object within the first screen 210 in the depth direction, identify the another input for moving the another object within the first screen 210 as the event, and according to identifying the event, adjust, through the distance adjusting unit 120, the distance.

The instructions, when executed by the at least one processor 130 individually or collectively, may cause the electronic device 101 to, based on an input requesting playback of content, playback the content by displaying the first screen 210 and the second screen 230 included in the content on the first display 111 and the second display 115, respectively, and identify a playback section for adjusting the distance as the event based on meta data with respect to the content.

The first display 111 may be configured to block transmission of light from a rear surface.

The electronic device 101 may further comprise a third display 425 disposed in front of the front surface of the second display 115 and configured to transmit light from a rear surface to a front surface, and another distance adjusting unit 435 configured to change another distance between the second display 115 and the third display 425. The instructions, when executed by the at least one processor 130 individually or collectively, may cause the electronic device 101 to display a third screen 405 through the third display 425, identify another event for moving an object 231 within the second screen 230 in a depth direction perpendicular to the second screen 230, and according to identifying the another event, adjust, through the another distance adjusting unit 435, the another distance between the second display 115 and the third display 425, and adjust, through the distance adjusting unit 120, the distance between the first display 111 and the second display 115 such that a distance between the first display 111 and the third display 425 is maintained during adjusting the another distance.

As described above, a method may be performed by an electronic device 101. The method may comprise displaying a first screen 210 through a first display 111, displaying a second screen 230 through a second display 115 disposed in front of the front surface of the first display 111 and configured to transmit light from a rear surface to a front surface, identifying an event for changing a distance, and according to identifying the event, adjusting, through a distance adjusting unit 120 configured to change a distance between the first display 111 and the second display 115, the distance between the first display 111 and the second display 115.

The method may comprise receiving a user input for moving an object 231 within the second screen 230 in a depth direction perpendicular to the second screen 230, and identifying the user input for moving the object 231 within the second screen 230 as the event.

The method may comprise, based on that the user input is an input for enlarging the object 231, adjusting the distance between the second display 115 and the first display 111 through the distance adjusting unit 120 such that the second display 115 is moved away from the first display 111, and based on that the user input is an input for reducing the object 231, adjusting the distance between the second display 115 and the first display 111 through the distance adjusting unit 120 such that the second display 115 is closer to the first display 111.

The method may comprise maintaining a size of the object 231 within the second screen 230 while adjusting the distance through the distance adjusting unit 120.

The method may comprise, based on that the input is an input for enlarging the object 231, adjusting the distance through the distance adjusting unit 120 such that the distance increases, and based on that the distance reaches a maximum distance, enlarging the size of the object 231 within the second screen 230.

The method may comprise, based on that the user input is an input for reducing the object 231, adjusting the distance through the distance adjusting unit 120 such that the distance decreases, and based on that the distance reaches a minimum distance, reducing the size of the object 231 within the second screen 230.

The method may comprise receiving another input for moving another object within the first screen 210 in the depth direction, identifying the another input for moving the another object within the first screen 210 as the event, and according to identifying the event, adjusting, through the distance adjusting unit 120, the distance.

The method may comprise, based on an input requesting playback of content, playing back the content by displaying the first screen 210 and the second screen 230 included in the content on the first display 111 and the second display 115, respectively, and based on meta data with respect to the content, identifying a playback section for adjusting the distance as the event.

The method may comprise displaying a third screen 405 through a third display 425 disposed in front of the front surface of the second display 115 and configured to transmit light from a rear surface to a front surface, identifying another event for moving an object 231 within the second screen 230 in a depth direction perpendicular to the second screen 230, and according to identifying the another event, adjusting, through another distance adjusting unit 435 configured to change another distance between the second display 115 and the third display 425, the another distance between the second display 115 and the third display 425, and adjusting, through the distance adjusting unit 120, the distance between the first display 111 and the second display 115 such that a distance between the first display 111 and the third display 425 is maintained during adjusting the another distance.

As described above, a non-transitory computer readable storage medium may store a program comprising instructions. The instructions, when executed individually or collectively by at least one processor 130 of an electronic device 101 comprising a first display 111 configured to emit light toward a front surface, a second display 115 disposed in front of the front surface of the first display 111 and configured to transmit light from a rear surface to a front surface, and a distance adjusting unit 120 configured to change a distance between the first display 111 and the second display 115, may cause the electronic device 101 to display a first screen 210 through the first display 111, display a second screen 230 through the second display 115, identify an event for changing the distance, and according to identifying the event, adjust, through the distance adjusting unit 120, the distance between the first display 111 and the second display 115.

The effects that may be obtained from the present disclosure are not limited to those described above, and any other effects not mentioned herein will be clearly understood by those having ordinary knowledge in the art to which the present disclosure belongs.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

What is claimed is:

1. An electronic device, comprising:
a first display configured to emit light toward a front surface of the first display;
a second display, to be disposed in front of the front surface of the first display, configured to transmit the light emitted toward the front surface of the first display from a rear surface of the second display to a front surface of the second display;
a distance adjusting unit configured to change a distance between the first display and the second display;
at least one processor comprising processing circuitry; and
a memory including one or more storage mediums to store instructions executable by the at least one processor, individually or collectively, which cause the electronic device to:
display a first screen through the first display,
display a second screen through the second display,
identify whether an event to change the distance between the first display and the second display occurs, and
adjust through the distance adjusting unit, based on the event being identified as having occurred, the distance between the first display and the second display.

2. The electronic device of claim 1,
wherein the instructions, when executed by the at least one processor individually or collectively, cause the electronic device to:
receive a user input to move an object within the second screen along a depth direction that is perpendicular to the second screen, and
identify the user input to move the object within the second screen as the event.

3. The electronic device of claim 2,
wherein the instructions, when executed by the at least one processor individually or collectively, cause the electronic device to:
identify whether the user input to move the object is to one of enlarge and reduce the object,
based on the user input being identified as being to enlarge the object, adjust the distance between the second display and the first display through the distance adjusting unit such that the second display is moved away from the first display, and
based on the user input being identified as being to reduce the object, adjust the distance between the second display and the first display through the distance adjusting unit such that the second display is closer to the first display.

4. The electronic device of claim 3,
wherein the instructions, when executed by the at least one processor individually or collectively, cause the electronic device to:
maintain a size of the object within the second screen while adjusting the distance through the distance adjusting unit.

5. The electronic device of claim 4,
wherein the instructions, when executed by the at least one processor individually or collectively, cause the electronic device to:
based on the user input being to enlarge the object:
adjust the distance through the distance adjusting unit such that the distance increases, and
based on that the distance reaches a maximum distance, enlarge the size of the object within the second screen.

6. The electronic device of claim 4,
wherein the instructions, when executed by the at least one processor individually or collectively, cause the electronic device to:
based on the user input being to reduce the object:
adjust the distance through the distance adjusting unit such that the distance decreases, and
based on that the distance reaches a minimum distance, reduce the size of the object within the second screen.

7. The electronic device of claim 2,
wherein the instructions, when executed by the at least one processor individually or collectively, cause the electronic device to:
receive another input to move another object within the first screen along the depth direction,
identify the another input to move the another object within the first screen as the event, and
according to identifying the event, adjust, through the distance adjusting unit, the distance.

8. The electronic device of claim 1,
wherein the instructions, when executed by the at least one processor individually or collectively, cause the electronic device to:
based on an input requesting playback of content:
playback the content by displaying the first screen and the second screen included in the content on the first display and the second display, respectively, and
based on meta data with respect to the content, identify a playback section for adjusting the distance as the event.

9. The electronic device of claim 1,
wherein the first display is configured to block transmission of light from the rear surface of the first display.

10. The electronic device of claim 1, further comprising:
a third display, disposed in front of the front surface of the second display, configured to transmit the light emitted toward the front surface of the second display from a rear surface of the third display to a front surface of the third display; and
another distance adjusting unit configured to change a distance between the second display and the third display, and
wherein the instructions, when executed by the at least one processor individually or collectively, cause the electronic device to:
display a third screen through the third display,
identify another event to move an object within the second screen along a depth direction that is perpendicular to the second screen, and
according to the identifying the another event:
adjust, through the another distance adjusting unit, the distance between the second display and the third display, and
adjust, through the distance adjusting unit, the distance between the first display and the second display such that a distance between the first display and the third display is maintained during adjusting the distance.

11. A method of an electronic device comprising:
displaying a first screen through a first display,
displaying a second screen through a second display disposed in front of a front surface of the first display, the second display being configured to transmit light emitted toward the front surface of the first display from a rear surface of the second display to a front surface of the second display,
identifying whether an event to change a distance between the first display and the second display occurs, and
adjusting, through a distance adjusting unit configured to change the distance between the first display and the second display, the distance between the first display and the second display based on the event being identified as having occurred.

12. The method of claim 11, comprising:
receiving a user input to move an object within the second screen along a depth direction that is perpendicular to the second screen, and
identifying the user input to move the object within the second screen as the event.

13. The method of claim 12, comprising:
identify whether the user input to move the object is to one of enlarge and reduce the object,
based on the user input being identified as being to enlarge the object, adjusting the distance between the second display and the first display through the distance adjusting unit such that the second display is moved away from the first display, and
based on the user input being identified as being to reduce, adjusting the distance between the second display and the first display through the distance adjusting unit such that the second display is closer to the first display.

14. The method of claim 13, comprising:
maintaining a size of the object within the second screen while adjusting the distance through the distance adjusting unit.

15. The method of claim 14, comprising:
based on the user input being to enlarge the object:
adjusting the distance through the distance adjusting unit such that the distance increases, and
based on that the distance reaches a maximum distance, enlarging the size of the object within the second screen.

16. The method of claim 14, comprising:
based on the user input being to reduce the object:
adjusting the distance through the distance adjusting unit such that the distance decreases, and
based on that the distance reaches a minimum distance, reducing the size of the object within the second screen.

17. The method of claim 12, comprising:
receiving another input to move another object within the first screen in the depth direction,
identifying the another input to move the another object within the first screen as the event, and
according to identifying the event, adjusting, through the distance adjusting unit, the distance.

18. The method of claim 11, comprising:
based on an input requesting playback of content:
playing back the content by displaying the first screen and the second screen included in the content on the first display and the second display, respectively, and
based on meta data with respect to the content, identifying a playback section for adjusting the distance as the event.

19. The method of claim 11,
wherein the first display is configured to block transmission of light from the rear surface of the first display.

20. The method of claim 11, comprising:
displaying a third screen through a third display, disposed in front of the front surface of the second display, the third display being configured to transmit the light emitted toward the front surface of the second display from a rear surface of the third display to a front surface of the third display,
identifying another event to move an object within the second screen along a depth direction that is perpendicular to the second screen, and
according to the identifying the another event:
adjusting, through another distance adjusting unit configured to change distance between the second display and the third display, the distance between the second display and the third display, and
adjusting, through the distance adjusting unit, the distance between the first display and the second display such that a distance between the first display and the third display is maintained during adjusting the distance.
